(19) United States
(12) Patent Application Publication
(10) Pub. No.: US 2018/0006847 A1
(43) Pub. Date: Jan. 4, 2018

(54) SAMPLER CIRCUIT WITH CURRENT INJECTION FOR PRE-AMPLIFICATION

(71) Applicants: Wenyan Vivian Jia, San Jose, CA (US); Ji Chen, Sunnyvale, CA (US); Shenggao Li, Pleasanton, CA (US); Fulvio Spagna, San Jose, CA (US); Xiaoqing Wang, Santa Clara, CA (US)

(72) Inventors: Wenyan Vivian Jia, San Jose, CA (US); Ji Chen, Sunnyvale, CA (US); Shenggao Li, Pleasanton, CA (US); Fulvio Spagna, San Jose, CA (US); Xiaoqing Wang, Santa Clara, CA (US)

(21) Appl. No.: 15/198,134

(22) Filed: Jun. 30, 2016

(51) Int. Cl. H04L 25/03

(52) U.S. Cl. CPC H04L 25/03057; H04L 25/03885

(57) ABSTRACT

Some embodiments include apparatus and methods using an input unit including a first transistor to receive a first signal of a differential signal pair, a second transistor to receive a second signal of the differential signal pair, and a third transistor to receive a clock signal, with the third transistor coupled to the first and second transistors at a node. The input unit includes a circuit component to form a first circuit path between the node and a supply node during a first phase of the clock signal. The third transistor is to form a second circuit path between the node and the supply node during a second phase of the clock signal. The apparatus includes an output unit coupled to the first and second transistors to generate output information based on voltages of the first and second signals during the second phase of the clock signal.

### TECHNICAL FIELD

Embodiments described herein pertain to input/output (I/O) circuitry. Some embodiments relate to equalizers and samplers in receivers.

### BACKGROUND

Many electronic devices or systems, such as computers, tablets, and cellular phones, include receivers to receive signals. The signals carry information (e.g., data) transmitted from one device to another device. A receiver usually has an equalizer circuit to improve the quality of analog signals received at the receiver and a sampler circuit to generate digital output information based on the analog signals. As the rate of data transferred between devices becomes higher (e.g., in Giga bits per second (Gbps) range), designing sampler circuits for receivers with enough voltage and timing margins to accommodate the higher data rate may pose a challenge.

### BRIEF DESCRIPTION OF THE DRAWINGS

FIG. 1 shows an apparatus including devices and a channel between the devices, according to some embodiments described herein.

FIG. 2 shows a block diagram of a receiver including receiver lanes and sampler circuits, according to some embodiments described herein.

FIG. 3A shows a schematic diagram of a sampler circuit, according to some embodiments described herein.

FIG. 3B shows an example of a circuit component that can be included in the sampler circuit of FIG. 3A, according to some embodiments described herein.

FIG. 3C is an example timing diagram for a differential signal pair and phases of a clock signal CLK in the sampler circuit of FIG. 3A, according to some embodiments described herein.

FIG. 4 shows an apparatus in the form of an electronic system, according to some embodiments described herein

FIG. 5 is a flowchart showing a method of operating a device including a sampler circuit, according to some embodiments described herein.

### DETAILED DESCRIPTION

The technique described herein relates to a sampler circuit that can operate to sample analog differential signals and generate digital output information based on the analog differential signals. The described sampler circuit can be configured to operate as a data sampler circuit or as an error sampler circuit in a receiver. Conventional data and error sampler circuits for high-speed transfer usually operate within defined parameters for both analog and digital domains. Such parameters include timing of clock to output (TCO), setup and hold time relative to the range of input signal swing, sampling speed, and noise margins. The described sampler circuit has improvements for some or all of these parameters over some conventional sampler circuits. For example, the described sampler circuit may have an improved TCO timing (e.g., fast enough TCO timing) to allow sufficient time for an equalization operation (decision feedback equalization (DFE) of the receiver). Improved TCO timing allows accuracy in handling a higher data transfer rate (e.g., Gbps range). The described sampler circuit may have an improved circuit noise (e.g., thermal noise) suppression that may counter the effect of signal-to-noise ratio (SNR) degradation in order to meet a shorter bit period associated with a high data rate transfer. As the receiver operating at high data rate (e.g., 20 Gbps or higher), kickback noise associated with sampling transition may not be able to settle within one unit interval (1 UI, e.g., within 50 ps). Especially if its previous analog stage has an unmatched output impedance due to device nonlinearity, common mode kickback noise converted to differential mode, thereby negatively affecting sampling accuracy in such conventional sampler circuits. The sampler circuit described herein may reduce the kickback noise in order to provide accurate sampling.

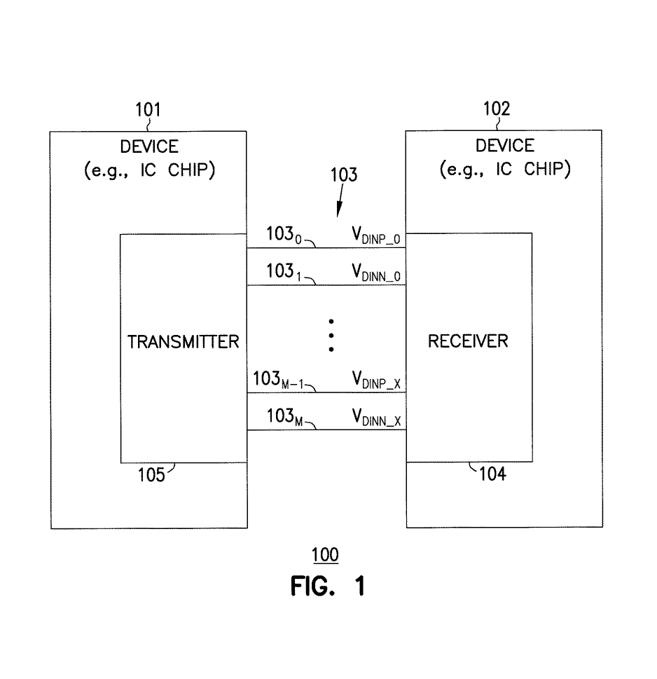

FIG. 1 shows an apparatus 100 including devices 101 and 102, and a channel 103 between devices 101 and 102, according to some embodiments described herein. Apparatus 100 can include or be included in an electronic device or system, such as a computer (e.g., server, desktop, laptop, or notebook), a solid state drive (SSD), a network device (e.g., Ethernet adapter, Ethernet controller, and other network devices), a tablet, a cellular phone, a wireless communication router, a digital television, an electronic wearable item (e.g., a smart watch or other wearable devices), other electronic devices or systems, and other internet of things (IoT) devices or systems.

In FIG. 1, each of devices 101 and 102 can include an integrated circuit (IC), such as an IC chip. Devices 101 and 102 can include a combination of a controller (e.g., processors (e.g., central processing unit (CPU)), I/O controllers, or memory controller), a memory device, and or other electronic devices. FIG. 1 shows an example where device 101 can be a memory device and device 102 can be a CPU.

Devices 101 and 102 can include a transmitter 105 and a receiver 104, respectively. Channel 103 can provide communication (e.g., in the form of signal transmission) between devices 101 and 102. Channel 103 can include lanes 103₀, 103₁, 103_{M-1}, and 103_{M} (where M is the number of lanes) to conduct signals between devices 101 and 102. Lanes 103₀, 103₁, 103_{M-1}, and 103_{M} can be used to carry pairs of differential signals or, alternatively, single-ended signals. Each of lanes 103₀, 103₁, 103_{M-1}, and 103_{M} can include a single conductive trace (or alternatively multiple conductive traces), such as metal-based traces of a bus on a circuit board (e.g., printed circuit board of an electronic system) where devices 101 and 102 are located. In an alternative arrangement, channel 103 does not have to include conductive lines on a circuit board. For example, channel 103 can include a medium (e.g., air) for wireless communication between devices 101 and 102.

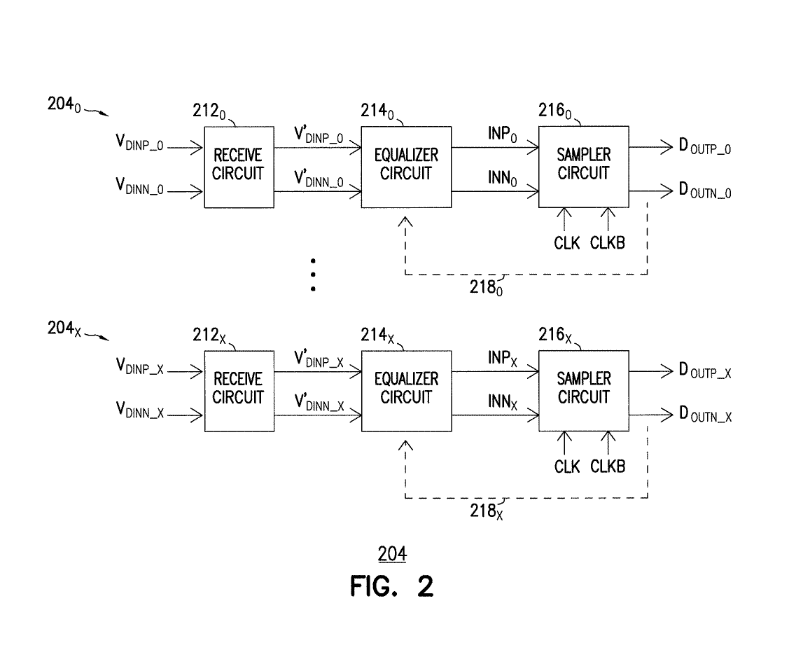

Devices 101 and 102 can communicate with each other by providing signals on lanes 103₀, 103₁, 103_{M-1}, and 103_{M}. As shown in FIG. 1, for example, transmitter 105 may transmit signals (e.g., data signals) V_{DINP}_{_}₀, V_{DINN}_{_}₀, V_{DINP}_{_}_{X}, and V_{DINN}_{_}_{X.} to receiver 104. These signals can carry information corresponding to bits transferred from transmitter 105. FIG. 1 shows an example where lanes 103₀, 103₁, 103_{M-1}, and 103_{M} are configured to carry differential signals, such that signals V_{DINP}_{_}₀ and V_{DINN}_{_}₀ can form a differential signal pair, and signals V_{DINP}_{_}_{X} and V_{DINN}_{_}_{X} can form another differential signal pair. However, lanes 103₀, 103₁, 103_{M-1}, and 103_{M} can be configured to carry single-ended signals. FIG. 1 shows two different signal pairs transmitted from transmitter 105 to receiver 104 and an example. However, the number of different signal pairs can vary. Receiver 104 can include components and operations of the receivers described below with reference to FIG. 2 through FIG. 5.

FIG. 2 shows a block diagram of a receiver 204 including receiver lanes 204₀ through 204_{X} and sampler circuits 216₀ through 216_{X}, according to some embodiments described herein. FIG. 2 shows an example where receiver 204 includes two receiver lanes 204₀ through 204_{X}. The number of receiver lanes can vary. Receiver 204 can correspond to receiver 104 of FIG. 1. Each of receiver lanes 204₀ through 204_{X} can receive a differential signal pair and generate respective digital output information (e.g., bits of information) that has a value based on the value of a respective received differential signal pair.

For example, receiver lane 204₀ can receive signals (e.g., analog input signals) V_{DINP}_{_}₀ and V_{DINN}_{_}₀ (e.g., a differential signal pair) and generate information D_{OUTP}_{_}₀ and D_{OUTN}_{_}₀ (e.g., digital output information). Receiver lane 204_{X} can receive signals V_{DIND}_{_}_{X} and V_{DINN}_{_}_{X} (e.g., a differential signal pair) and generate information D_{OUTP}_{_}_{X} and D_{OUTN}_{_}_{X} (e.g., digital output information). Signals V_{DINP}_{_}₀, V_{DINN}_{_}₀, V_{DINP}_{_}_{X}, and V_{DINN}_{_}_{X} can be provided to receiver 204 by a transmitter, such as transmitter 105 of FIG. 1. In FIG. 2, each of information D_{OUTP}_{_}₀, D_{OUN}_{_}₀, D_{OUTP}_{_}_{X}, and D_{OUTN}_{_}_{X} can be represented by a digital signal that carries bits (e.g., data bits). Information D_{OUTP}_{_}₀ and D_{OUTN}_{_}₀ can carry bits having complementary values (e.g., logic 0 and logic 1). Information D_{OUTP}_{_}_{X} and D_{OUTN}_{_}_{X} can carry bits having complementary values (e.g., logic 0 and logic 1).

As shown in FIG. 2, receiver lane 204₀ can include a receive circuit 212₀, an equalizer circuit 214₀, and sampler circuits 216₀. Receive circuit 212₀ can include a linear equalizer (e.g., a continuous time linear equalizer (CTLE)). Receive circuit 212₀ can perform an equalization operation (e.g., a CTLE operation) to equalize (e.g., reduce noise) signals V_{DINP}_{_}₀ and V_{DINN}_{_}₀ and generate signals (e.g., equalized input signals) V′_{DINP}_{_}₀ and V′_{DINN}_{_}₀.

Equalizer circuit 214₀ can include a feed forward equalizer (FFE), a DFE, or combination of FFE and DFE. Equalizer circuit 214₀ can perform an equalization operation (e.g., FFE operation, DFE operation, or both FFE and DFE operations) on signals V′_{DINP}_{_}₀ and V′_{DINN}_{_}₀ and generate signals INP₀ and INN₀ (e.g., equalized signals (equalized different signal pair)).

Sampler circuits 216₀ can generate information D_{OUTP}_{_}₀ and D_{OUTN}_{_}₀ based on signals V′_{DINP}_{_}₀ and V′_{DINN}_{_}₀. Sampler circuit 216₀ can be used as a data sampler circuit (or as an error sampler circuit). Sampler circuit 216₀ can receive clock signals (e.g., complementary clock signals) CLK and CLKB and sample signals V′_{DINP}_{_}₀ and V′_{DINN}_{_}₀ (to generate information D_{OUTP}_{_}₀ and D_{OUTN}_{_}₀) based on timing (e.g., phases) of clock signals CLK and CLKB. Information D_{OUTP}_{_}₀ and D_{OUTN}_{_}₀ can be provided to other components (not shown) coupled to receive lane 204₀ for further processing. As shown in FIG. 2, receive lane 204₀ can include a path (e.g., feedback path) 218₀ to provide one or both of information D_{OUTP}_{_}₀ and D_{OUTN}_{_}₀ to equalizer circuit 214₀, which may use one or both of information D_{OUTP}_{_}₀ and D_{OUTN}_{_}₀ to provide feedback for digital equalizer (e.g., DFE operation).

In a similar arrangement, receiver lane 204_{X} can include a receive circuit 212_{X}, an equalizer circuit 214_{X}, sampler circuit 216_{X}, and a path 218_{X}. Similar to receiver lane 204₀, receiver lane 204_{X} can operate to receive signals V_{DINP}_{_}_{X} and V_{DINN}_{_}_{X} and generate signal V′_{DINP}_{_}_{X} and V′_{DINN}_{_}_{X}, signals INP_{X} and INN_{X}, and information D_{OUTP}_{_}_{X} and D_{OUTN}_{_}_{X}.

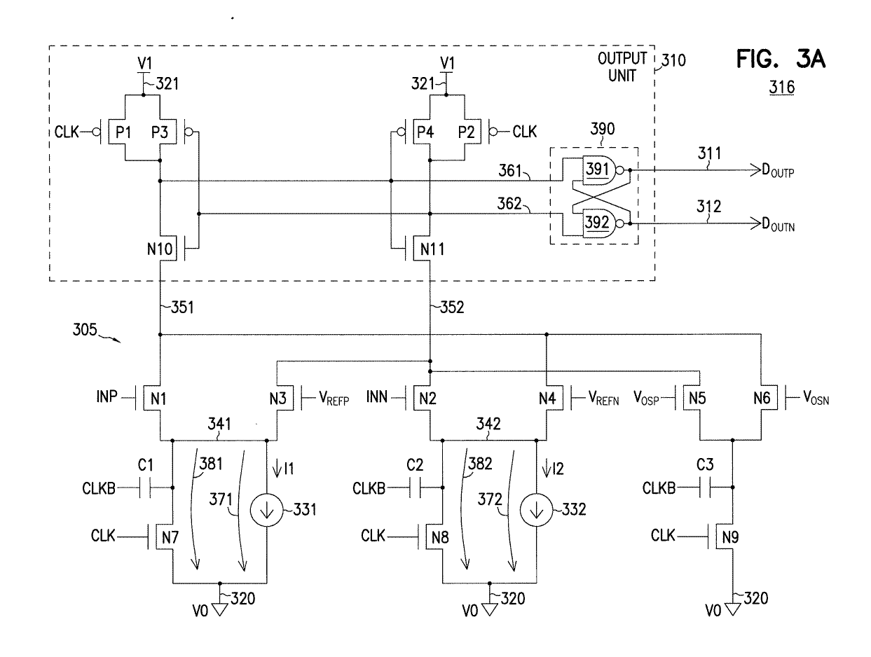

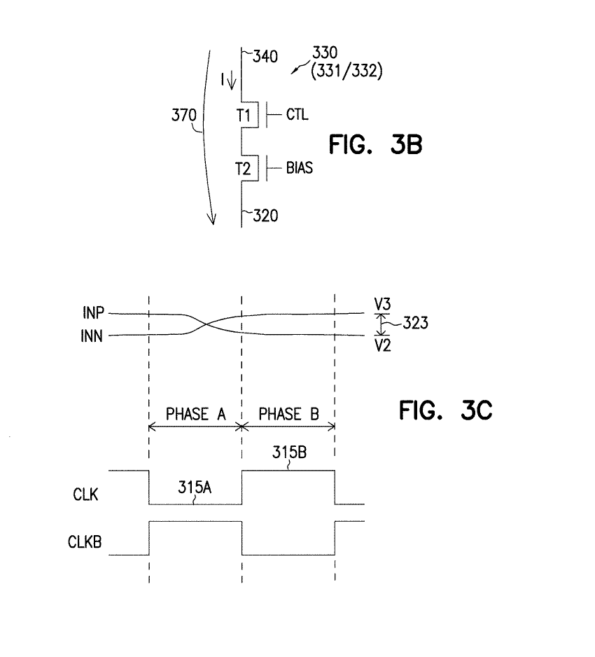

Each of sampler circuits 216₀ and 216_{X} can include components and operations of the sampler circuits described below with reference to FIG. 3A through FIG. 5.

FIG. 3A shows a schematic diagram of a sampler circuit 316, according to some embodiments described herein. Sampler circuit 316 can be included as each of sampler circuits 216₀ and 216_{X} or receiver 204 of FIG. 2. As shown in FIG. 3A, sampler circuit 316 can include an input unit 305 that includes transistors N1 through N9, capacitors C1, C2 and C3, and circuit components 331 and 332. Sampler circuit 316 can include an output unit 310 that includes transistors P1 through P4, N10, and N11, and an output latch (e.g., SR latch) 390 including gates (e.g., NAND gates) 391 and 392. Each of transistors P1 through P4 can include a field effect transistor (FET), such as a p-channel metal-oxide semiconductor (PMOS) transistor. Each of transistors N1 through N11 can include an n-channel metal-oxide semiconductor (NMOS) transistor.

Input unit 305 can operate to receive signals INP and INN at the gates of a pair of transistors that includes transistors N1 and N2. Signals INP and INN can correspond to signals INP₀ and INN₀ or signals INP_{X} and INN_{X} of FIG. 2. Sampler circuit 316 can include transistors N3 and N4 to receive signals (differential reference signals) V_{REFP} and V_{REFN} (e.g., analog input reference signals) at respective gates of transistors N3 and N4. Sampler circuit 316 can include transistors N5 and N6 to receive signals V_{OSP} and V_{OSN} (e.g., analog input offset cancellation signals) at respective gates of transistors N5 and N6.

Output unit 310 can operate to generate information D_{OUTP} and D_{OUTN} at output nodes 311 and 312, respectively. Information D_{OUTP} and D_{OUTN} can correspond to information D_{OUTP}_{_}₀ and D_{OUTN}_{_}₀ or D_{OUTP}_{_}_{X} and D_{OUTN}_{_}_{X} of FIG. 2. Each of information D_{OUTP} and D_{OUTN} is digital output information and can be represented by a digital signal that carries bits (e.g., data bits). The values of information D_{OUTP} and D_{OUTN} can be complementary to each other. For example, when information D_{OUTP} has a value corresponding to logic 1, information D_{OUTN} has a value corresponding to logic 0, and vice versa. In this example, the voltage value of a signal that represents information D_{OUTN} can be zero and the voltage value of a signal that represents information D_{OUTP} can be at a value of a supply voltage (e.g., Vcc) of sampler circuit 316.

Sampler circuit 316 can include supply nodes 320 and 321 to receive voltages V0 and V1, respectively. Voltage V1 (e.g., a positive voltage) can include a supply voltage (e.g., Vcc) of sampler circuit 316. Supply node 320 can be coupled to ground (e.g., Vss) such that voltage V0 can have a value of zero volts. Sampler circuit 316 can receive a clock signal CLK at the gates of transistors P1, P2, N7, N8, and N9, and an inverted version of clock signal CLK at a plate of each of capacitors C1, C2, and C3.

As shown in FIG. 3A, circuit component 331 can be coupled in parallel with transistor N7 between a node 341 and supply node 320. Circuit component 331 can operate to generate a current I1 (e.g., a constant bias current) between a node 341 and supply node 320. For example, during part of the operation of sampler circuit 316, circuit component 331 can form a circuit path (e.g., a current path) 371 between nodes 341 and 320 and cause current I1 to flow between nodes 341 and 320 through circuit path 371.

Circuit component 332 can be coupled in parallel with transistor N8 between a node 342 and supply node 320. Circuit component 332 can operate to generate a current I2 (e.g., a constant bias current) between a node 342 and supply node 320. For example, circuit component 332 can form a circuit path (e.g., a current path) 372 between nodes 342 and 320 and cause current I2 to flow between nodes 342 and 320 through circuit path 372.

FIG. 3B shows an example of a circuit component 330 that can be used as each of circuit components 331 and 332 of FIG. 3A, according to some embodiments described herein. As shown in FIG. 3B, circuit component 330 can include a current source, which can include transistors T1 and T2 to generate a current I. Current I can correspond to current I1 or I2 of FIG. 3A. As shown in FIG. 3B, transistor T1 can be controlled (e.g., turned on) by a signal CTL (e.g., control signal). Transistor T2 can be controlled (e.g., turned on) by a signal BIAS (e.g., bias signal). Signals CTL and BIAS can be provided with voltages to turn on transistors T1 and T2 to form a circuit path (e.g., a current path) 370 between nodes 340 and 320. Current I can flow between nodes 340 and 320 through circuit path 370 (e.g., through transistors T1 and T2). Node 340 can correspond to node 341 or node 342 of FIG. 3A, node 320 in FIG. 3B can correspond to supply node 320 of FIG. 3A. Circuit path 370 can correspond to circuit path 371 or circuit path 372 of FIG. 3A. FIG. 3B shows circuit component 330 that includes a current source having two transistors (T1 and T2) as an example. However, circuit component 330 can include a different structure as long as circuit component 330 can provide a current (e.g., a constant current) between nodes 340 and 320.

Referring to FIG. 3A, sampler circuit 316 can also include a circuit path 381 (e.g., a current path) between nodes 341 and 320 through transistor N7. Circuit path 381 is different from circuit path 371. Circuit path 381 is parallel with circuit path 371 between nodes 341 and 320. Transistor N7 can be controlled (e.g., turned on or turned off) by clock signal CLK. Circuit path 381 can be formed when transistor N7 is turned on. Circuit paths 371 and 381 may be formed at different times. For example, in one phase of the operation of sampler circuit 316, circuit component 331 may form circuit path 371 (and cause current I1 to flow between nodes 341 and 320) while circuit path 381 is not formed (e.g., transistor N7 is turned off). In another phase of the operation of sampler circuit 316, transistor N7 is turned on to form circuit path 381 through transistor N7 while circuit component 331 may not form circuit path 371 (e.g., may not cause current I1 to flow between nodes 341 and 320).

Sampler circuit 316 can also include a circuit path 382 (e.g., a current path) between nodes 342 and 320 through transistor N8. Circuit path 382 is different from circuit path 372. Circuit path 382 is parallel with circuit path 372 between nodes 342 and 320. Transistor N8 can be controlled (e.g., turned on or turned off) by clock signal CLK. Circuit path 382 can be formed when transistor N8 is turned on. Circuit paths 372 and 382 may be formed at different times. For example, in one phase of the operation of sampler circuit 316, circuit component 332 may form circuit path 372 (and cause current I2 to flow between nodes 342 and 320) while circuit path 372 is not formed (e.g., transistor N8 is turned off). In another phase of the operation of sampler circuit 316, transistor N8 is turned on to form circuit path 382 through transistor N8 while circuit component 332 may not form circuit path 372 (e.g., may not cause current I2 to flow between nodes 342 and 320).

Thus, as described above, during one phase of the operation of sampler circuit 316, circuit paths 371 and 372 can be formed (to allow the flow of currents I1 and I2, respectively) while circuit paths 381 and 382 may not be formed. During another phase of the operation of sampler circuit 316, circuit paths 381 and 382 can be formed while circuit paths 371 and 372 may not be formed (e.g., currents I1 and I2 may not flow).

FIG. 3C shows an example timing diagram for signals INP and INN, and phase A and phase B of clock signal CLK of FIG. 3A, according to some embodiments described herein. As shown in FIG. 3, clock signal CLK can have phase A and phase B corresponding time intervals when clock signal CLK has different levels. For example, phase A can correspond to a time interval when clock signal CLK has a level 315A (e.g., “low” or zero volts), while phase B can correspond to a time interval when clock signal CLK has a level 315B (e.g., “high” or Vcc).

Signals INP and INN can have different voltages and can swing within a range 323 (e.g., a range of input signal swing) between voltages V2 and V3. Each of voltages V2 and V3 can have a positive value that can be greater than the value of voltage V0 (e.g., Vss) and less than the value of voltage V1 (e.g., Vcc). Based on the difference in values between voltages of signals INP and INN during phase A and phase B, output unit 310 (FIG. 3A) of sampler circuit 316 (FIG. 3A) can perform pre-amplification at nodes 351 and 352, sense and amplification (an additional amplification after the pre-amplification), regeneration at nodes 361 and 362, and output generation to generate information D_{OUTP} and D_{OUTN} that have values (e.g., bit values) based on the values of voltages of signals INP and INN. The following description of the operation of sampler circuit 316 refer to FIG. 3A and FIG. 3C.

In operation, during phase A (when signal CLK is at level 315A in FIG. 3C), output unit 310 (FIG. 3A) can operate to reset nodes 361 and 362 (e.g., pre-charge nodes 361 and 362) such that the values of voltages of nodes 361 and 362 can be equal (or substantially equal). During phase A, transistors P1 and P2 (which are controlled by signal CLK) are turned on to couple node 361 to supply node 321 (through transistor P1) and to couple node 362 to supply node 321 (through transistor P2). Thus, nodes 361 and 362 are charged (e.g., pre-charged) to the voltage at supply node 321, which is voltage V1. Hence, the value (e.g., pre-charge value) of the voltage at each of nodes 361 and 362 can be equal to the value of voltage V1. During phase A, transistors N10 and N11 are turned off. Thus, the voltage at nodes (e.g., internal nodes) 351 and 352 can be held at a voltage equal to V1−Vth (where Vth is the threshold voltage of transistors N10 and N11). Hence, during phase A, the circuit loadings of a circuit portion formed by transistors P1, P3, and N10 and a circuit portion formed by transistors P2, P4, and N11 can be balanced. During phase A, capacitor C1 can operate to quickly charge node 341, and capacitor C2 can operate to quickly charge node 342. The operations of capacitors C1 and C2 may help increase the trans-conductance of signals INP and INN during transition. Capacitor C3 can operate to quickly charge the node between transistor N9 and transistors N5 and N6. Transistors N5 and N6 can operate to receive signals V_{OSP} and V_{OSN} in order to correct offset at nodes 351 and 352.

During phase B (when signal CLK is at level 315B in FIG. 3C), transistors P1 and P2 (FIG. 3A) are turned off. The amplitudes (e.g., voltage values) of signals INP and INN are compared with the amplitudes (e.g., voltage values) of signals V_{REFP} and V_{REFN}, respectively (as well as offset value of “V_{OSP}−V_{OSN}”). For example, the voltage difference between signals INP and V_{REFP} and the voltage difference between signals INN and V_{REFN} are sensed and amplified at nodes 351 and 352. Comparing signals INP and INN with signals V_{REFP} and V_{REFN}, respectively may improve the linearity of sampler circuit 316.

During phase B, output unit 310 can perform regeneration operation, such that the value of the voltages at one of nodes 361 and 362 can change (e.g., decrease) from the pre-charged value (e.g., the value during the reset stage before the regeneration stage). As described above, the pre-charged value can be the value of voltage V1. For example, during phase B, transistors P3 and N10 can operate to cause the value of the voltage at node 361 to decrease (e.g., decrease from pre-charge value) if the value of the voltage of signal INP is greater than the value of the voltage of signal INN. In this example, transistors P4 and N11 may cause the value of the voltage at node 362 to remain unchanged (or substantially unchanged) at the pre-charge value (e.g., the value of voltage V1). In another example, during phase B, transistors P4 and N11 can operate to cause the value of the voltage at node 362 to decrease (e.g., decrease from pre-charge value) if the value of the voltage of signal INN is greater than the value of the voltage of signal INP. In this example, transistors P3 and N10 may cause the value of the voltage at node 361 to remain unchanged (or substantially unchanged) at the pre-charge value (e.g., the value of voltage V1).

Latch 390 can operate to generate information D_{OUTP}_{_}₀ and D_{OUTN}_{_}₀ based on voltages at nodes 361 and 362 during phase B. As described above, the voltages at nodes 361 and 362 are based on the voltages of signals INP and INN during phase B. Gate 391 and 392 of latch 390 can operate such that information D_{OUTP} and D_{OUTN} can include bits having complementary values (e.g., logic 0 and logic 1). For example, if the value of the voltage at node 361 is less than the value of the voltage at node 362, then information D_{OUTP} and D_{OUTN} can include bits having values of logic 1 and logic 0, respectively. If the value of the voltage at node 361 is greater than the value of the voltage at node 362, then information D_{OUTP} and D_{OUTN} can include bits having values of logic 0 and logic 1, respectively. FIG. 3A shows latch 390 including NAND gates (e.g., gates 391 and 392) as an example. However, latch 390 can include a different type of latch.

As mentioned above, sampler circuit 316 may use components 331 and 332 to form circuit paths 371 and 372 (to allow the flow of currents I1 and I2, respectively) during part of its operation. Using circuit components 331 and 332 may further improve the speed (e.g., provide faster TCO timing) and other operational parameters of sampler circuit 316. For example, during phase A, while nodes 361 and 362 are pre-charged (e.g., charged to voltage V1) as described above, sampler circuit 305 can perform an amplification operation, which is considered as a pre-amplification operation (e.g., an amplification performed in phase A before the sense and amplification performed during phase B). The pre-amplification operation may speed up the operation (e.g., sense and amplification, and regeneration) of sampler circuit 316 performed after phase A. For example, during phase A, with the injection of currents (e.g., constant bias currents) I1 and I2, sampler circuit 305 can amplify (e.g., pre-amplify) the differential signal (a difference in voltages) at nodes 351 and 352 (while nodes 361 and 362 are charged (e.g., pre-charged) to voltage V1). The value of each of currents I1 and I2 can be programmed (e.g., at a relatively small value) such that gain of the pre-amplification during phase A can be relatively small. This prevents output unit 310 from performing the regeneration (e.g., to avoid incorrect voltages at nodes 361 and 362) even if signals INP and INN may have a large input swing during phase A. In phase B (when signal CLK is at level 315B), the gain can be higher. Since a pre-amplification is performed during phase A (e.g., before clock signal CLK is at level 315B during phase B), output unit 310 can quickly regenerate the voltage difference at nodes 361 and 362 (which is based on the values of signals INP and INN during phase B). This quick regeneration may improve the speed (e.g. TCO) of sampler circuit 316.

Circuit components 331 and 332 may further improve the suppression of thermal noise of sampler circuit 316. For example, the existence of currents I1 and I2 during phase A (e.g., before signals INP and INN are sampled during phase B) may add a constant trans-conductance (gm) at signals INP and INN. The trans-conductance can be non-zero during phase A and phase B. Generation of currents I1 and I2 during phase A may increase the trans-conductance value in comparison with the trans-conductance value where currents I1 and I2 are not generated (e.g., where circuit paths 371 and 372 are not formed). The increase in the trans-conductance value may help reduce the thermal noise of sampler circuit 316.

Circuit components 331 and 332 may further reduce kickback noise at signals INP and INN. For example, the generation of currents I1 and I2 may lower the voltages at nodes 341, 342, 351, and 352 during phase A (e.g., during pre-charging of nodes 361 and 362). This may reduce the voltage swing at nodes 341, 342, 351, and 352. Thus, from phase A to phase B, the voltage swing of the voltages at nodes 341, 342, 351, and 352 may also be lower in comparison with the voltage swing where currents I1 and I2 are not generated. The lower voltage swing (resulting from the generation of currents I1 and I2) may help reduce the kickback noise and may avoid adding extra loading (e.g., an extra stage (or stages) for a summer of an equalizer circuit (e.g., equalizer circuit to 214₀ in FIG. 2) coupled to sampler circuit 316.

Thus, as described above, during one phase (e.g., during phase A where reset/pre-change stage is performed before sampling signals INP and INN), sampler circuit 316 can amplify (e.g., pre-amplify) the differential signal at nodes 351 and 352 without regeneration (e.g., without causing the values of the voltages at nodes 361 and 362 to change from a pre-charged value). During another phase (e.g., during phase B after the reset/pre-change stage is performed), sampler circuit 316 can quickly amplify the differential signal and regenerate a result and convert it into information D_{OUTP} and D_{OUTN}. These operations may allow sampler circuit 316 to reduce the TCO timing (e.g., faster TCO timing), reduce thermal noise, and reduce kickback noise, as mentioned above. Thus, voltage and timing margins for sampler circuit 316 may also be improved.

FIG. 3A shows an example where sampler circuit 316 includes NMOS transistors (e.g., N1 through N6) as input devices to receive respective signals (e.g., INP, INN, V_{REFP}, V_{REFN}, V_{OSP}, and V_{OSN}) at their gates. However, sampler circuit 316 may alternatively use PMOS transistors as input devices to receive signals at their respective gates.

As shown in FIG. 3A, sampler circuit 316 can use signals INP, INN, V_{REFP}, V_{REFN}, V_{OSP}, and V_{OSN} to generate information D_{OUTP} and D_{OUTN}. In an alternative arrangement, sampler circuit 316 may be configured (e.g., configured as a data sampler circuit) such that it may use signals INP and INN, V_{OSP}, and V_{OSN} to generate information D_{OUTP} and D_{OUTN} without using signals V_{REFP} and V_{REFN}. Thus, in alternative arrangement, some components shown in FIG. 3A can be excluded (e.g., removed) from sampler circuit 316.

For example, in one alternative arrangement, transistors N2, N4, N8, and N9, capacitor C2, and circuit component 332 can be excluded from sampler circuit 316. In this example, signals V_{REFP} and V_{REFN} can be excluded from sampler circuit 316, and signal INN (instead of signal V_{REFP}) can be provided to the gate of transistor N3. In this alternative arrangement, sampler circuit 316 can compare signals INP and INN directly with each other during the operations described above (e.g., pre-amplification, sense and amplification, regeneration, and output generation).

In another alternative arrangement, transistors N5, N6, N9, and capacitor C3 can be excluded from sampler circuit 316. In this alternative arrangement, signals V_{OSP} and V_{OSN} can be excluded from sampler circuit 316. Sampler circuit 316 can use signals INP, INN, V_{REFP}, and V_{REFN} during the operations described above (e.g., pre-amplification, sense and amplification, regeneration, and output generation).

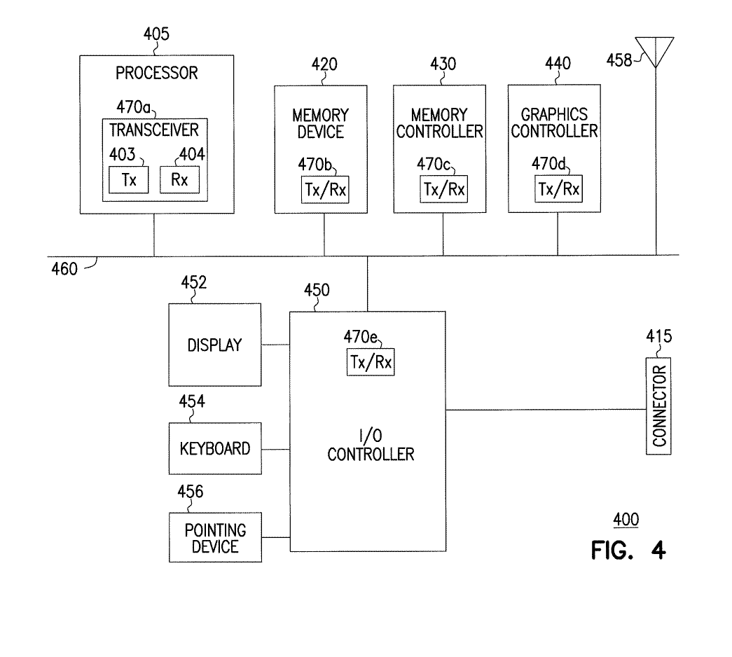

FIG. 4 shows an apparatus in the form of a system (e.g., electronic system) 400, according to some embodiments described herein. System 400 can include or be included in a computer, a tablet, or other electronic system. As shown in FIG. 4, system 400 can include components, such as a processor 405, a memory device 420, a memory controller 430, a graphics controller 440, an I/O controller 450, a display 452, a keyboard 454, a pointing device 456, at least one antenna 458, a connector 415, and a bus 460. Bus 460 can include conductive lines (e.g., metal-based traces on a circuit board where the components of system 400 are located).

In some arrangements, system 400 does not have to include a display. Thus, display 452 can be omitted from system 400. In some arrangements, system 400 does not have to include any antenna 458. Thus, antenna 458 can be omitted from system 400.

Processor 405 can include a general-purpose processor or an application specific integrated circuit (ASIC). Processor 405 can include a CPU.

Memory device 420 can include a dynamic random access memory (DRAM) device, a static random access memory (SRAM) device, a flash memory device, phase change memory, a combination of these memory devices, or other types of memory. FIG. 4 shows an example where memory device 420 is a stand-alone memory device separated from processor 405. In an alternative arrangement, memory device 420 and processor 405 can be located on the same die. In such an alternative arrangement, memory device 420 is an embedded memory in processor 405, such as embedded DRAM (eDRAM), embedded SRAM (eSRAM), embedded flash memory, or another type of embedded memory.

Display 452 can include a liquid crystal display (LCD), a touchscreen (e.g., capacitive or resistive touchscreen), or another type of display. Pointing device 456 can include a mouse, a stylus, or another type of pointing device.

I/O controller 450 can include a communication module for wired or wireless communication (e.g., communication through one or more antenna 458). Such wireless communication may include communication in accordance with WiFi communication technique, Long Term Evolution Advanced (LTE-A) communication technique, or other communication techniques.

I/O controller 450 can also include a module to allow system 400 to communicate with other devices or systems in accordance with to one or more of the following standards or specifications (e.g., I/O standards or specifications), including Universal Serial Bus (USB), DisplayPort (DP), High-Definition Multimedia Interface (HDMI), Thunderbolt, Peripheral Component Interconnect Express (PCIe), Ethernet, and other specifications.

Connector 415 can be arranged (e.g., can include terminals, such as pins) to allow system 400 to be coupled to an external device (or system). This may allow system 400 to communicate (e.g., exchange information) with such a device (or system) through connector 415.

Connector 415 and at least a portion of bus 460 can include conductive lines that conform with at least one of USB, DP, HDMI, Thunderbolt, PCIe, Ethernet, and other specifications.

As shown in FIG. 4, processor 405 can include a transceiver (Tx/Rx) 470a having a transmitter (Tx) 403 and a receiver (Rx) 404. Transmitter 403 can operate to transmit information from processor 405 to another part of system 400 or to an external device (or system) coupled to connector 415. Receiver 404 of processor 405 can operate to receive information from another part of system 400 or from an external device (or system) coupled to connector 415. For example, receiver 404 can receive information (e.g., data signals) from one or more of memory device 420, memory controller 430, graphics controller 440, and I/O controller 450. Receiver 404 can include components and operation of any of the receivers and sampler circuits described above with reference to FIG. 1 through FIG. 3C.

As shown in FIG. 4, memory device 420, memory controller 430, graphics controller 440, and I/O controller 450 can include transceivers 470b, 470c, 470d, and 470e, respectively, to allow each of these components to transmit and receive information through their respective transceiver. At least one of transceivers 470b, 470c, 470d, and 470e can be similar to or identical to transceiver 470a. Thus, at least one of transceivers 470b, 470c, 470d, and 470e can include a receiver similar to or identical to receiver 404. For example, at least one of transceivers 470b, 470c, 470d, and 470e can include a receiver that can be arranged to allow at least one of memory device 420, memory controller 430, graphics controller 440, and I/O controller 450 to receive information (e.g., data and clock signals) from another part of system 400 or from an external device (or system) coupled to connector 415.

FIG. 4 shows the components of system 400 arranged separately from each other as an example. For example, each of processor 405, memory device 420, memory controller 430, graphics controller 440, and I/O controller 450 can be located on a separate IC (e.g., semiconductor die or an IC chip). In some arrangements, two or more components (e.g., processor 405, memory device 420, graphics controller 440, and I/O controller 450) of system 400 can be located on the same die (e.g., same IC chip) that forms a system-on-chip (SoC).

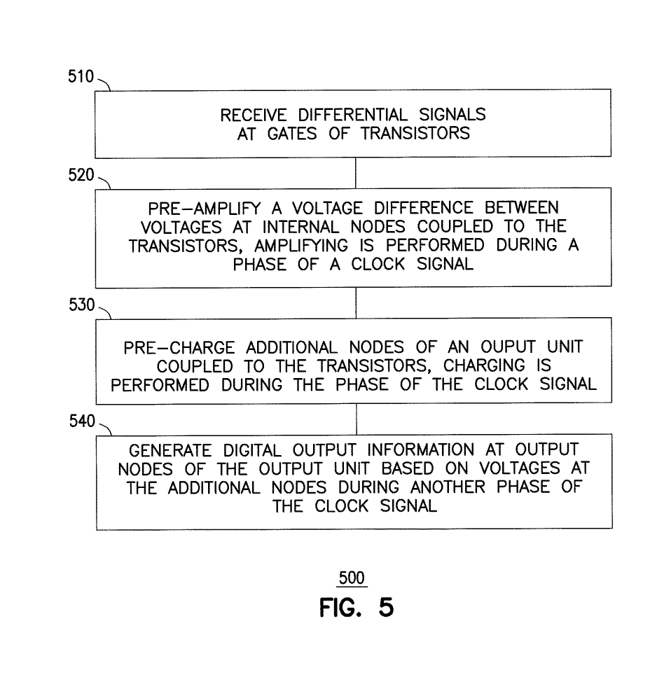

FIG. 5 is a flowchart showing a method 500 of operating a device including a sampler circuit, according to some embodiments described herein. The device used in method 500 can include any of the devices described above with reference to FIG. 1 through FIG. 4. Some of the activities in method 500 may be performed by hardware, software, firmware, or any combination of hardware, software, and firmware. Such hardware, software, and firmware can be included in the device or system that includes the device.

As shown in FIG. 5, activity 510 of method 500 can include receiving differential signals at gates of transistors. The transistors can be included in a sampler circuit (e.g., sampler circuit 316). Activity 520 can include pre-amplifying (e.g., pre-amplifying) a voltage difference between voltages at internal nodes coupled to the transistors. Activity 520 can be performed during a phase of a clock signal. Activity 530 can include pre-charging additional nodes of an output unit coupled to the transistors (e.g., output unit 310 of sampler circuit 316). Activity 530 can be performed during the phase of the clock signal (e.g., the same phase of the clock in activity 520). Activity 540 can include generating digital output information at output nodes of the output unit based on voltages at the additional nodes during another phase of the clock signal.

Method 500 can include fewer or more activities relative to activities 510, 520, 530, and 540 shown in FIG. 5. For example, method 500 can include activities and operations of any of the receivers and the sampler circuits (e.g., sampler circuit 316) described above with reference to FIG. 1 through FIG. 4.

The illustrations of the apparatuses (e.g., apparatus 100 and system 400 including receivers and sampler circuits included in the receivers, such as receiver 104, receiver 204, and sampler circuit 316) and methods (e.g., method 500 and operations of apparatus 100 and system 400 including operations receivers and sampler circuits included in the receivers) described above are intended to provide a general understanding of the structure of different embodiments and are not intended to provide a complete description of all the elements and features of an apparatus that might make use of the structures described herein.

The apparatuses and methods described above can include or be included in high-speed computers, communication and signal processing circuitry, single-processor module or multi-processor modules, single embedded processors or multiple embedded processors, multi-core processors, message information switches, and application-specific modules including multilayer or multi-chip modules. Such apparatuses may further be included as sub-components within a variety of other apparatuses (e.g., electronic systems), such as televisions, cellular telephones, personal computers (e.g., laptop computers, desktop computers, handheld computers, etc.), tablets (e.g., tablet computers), workstations, radios, video players, audio players (e.g., MP3 (Motion Picture Experts Group, Audio Layer 3) players), vehicles, medical devices (e.g., heart monitors, blood pressure monitors, etc.), set top boxes, and others.

### ADDITIONAL NOTES AND EXAMPLES

Example 1 includes subject matter (such as a device, an electronic apparatus (e.g., circuit, electronic system, or both), or a machine) including a first transistor to receive a first signal of a differential signal pair, a second transistor to receive a second signal of the differential signal pair, a third transistor to receive a clock signal, the third transistor coupled to the first and second transistors at a node, a circuit component to form a first circuit path between the node and a supply node during a first phase of the clock signal, and the third transistor to form a second circuit path between the node and the supply node during a second phase of the clock signal, and an output unit coupled to the first and second transistors to generate output information based on voltages of the first and second signals during the second phase of the clock signal.

In Example 2, the subject matter of Example 1 may optionally include, wherein the circuit component includes a current source coupled between the node and the supply node.

In Example 3, the subject matter of Example 1 or 2 may optionally include, wherein the output unit includes a transistor between the first transistor and a first node, and another transistor between the second transistor and a second node, and the output circuit is to couple each of the first and second nodes to an additional supply node during the first time interval.

In Example 4, the subject matter of Example 3 may optionally include, wherein the output circuit is to cause the voltage at one of the first and second nodes to change during the second phase of the clock signal

In Example 5, the subject matter of Example 1 or 2 may optionally include, wherein a first additional transistor coupled to the first transistor to receive a first additional signal, a second additional transistor coupled to the second transistor to receive a second additional signal, a third additional transistor to receive the clock signal, the third additional transistor coupled to the first and second additional transistors at an additional node, and an additional circuit component to form a first circuit path between the additional node and the supply node during the first phase of the clock signal, and the third additional transistor to form an additional circuit path between the additional node and the supply node during the second phase of the clock signal.

Example 6 includes subject matter (such as a device, an electronic apparatus (e.g., circuit, electronic system, or both), or a machine) including a first transistor coupled between a first node and an a first internal node, a second transistor coupled between the first node and a second internal node, a third transistor coupled between the first node and a first supply node, a circuit component coupled between the first node and the first supply node, a fourth transistor coupled between the first internal node and a first additional node, a fifth transistor coupled between the second internal node and a second additional node, a sixth transistor coupled between the first additional node and a second supply node, a seventh transistor coupled between the first additional node and the second supply node, an eighth transistor coupled between the second additional node and the second supply node, and a ninth transistor coupled between the second additional node and the second supply node.

In Example 7, the subject matter of Example 6 may optionally include, wherein component includes a transistor coupled in parallel with the third transistor between the first node and the first supply node.

In Example 8, the subject matter of Example 6 may optionally include, further comprising a tenth transistor coupled between a second node and the second internal node, an eleventh transistor coupled between the second node and the first internal node, and a twelfth transistor coupled between the second node and the first supply node.

In Example 9, the subject matter of Examples 8 may optionally include, further comprising an additional circuit component coupled between the second node and the first supply node.

In Example 10, the subject matter of Example 9 may optionally include, further comprising an output latch coupled to the first and second additional nodes.

In Example 11, the subject matter of Example 6 may optionally include, further comprising a capacitor coupled to the first node, wherein

Example 12 includes subject matter (such as a device, an electronic apparatus (e.g., circuit, electronic system, or both), or a machine) including an equalizer circuit to generate equalized signals based on input signals, and a sampler circuit including a pair of transistors to receive the equalized signals, the pair of transistors coupled to internal nodes, the sampler circuit to receive a clock signal and amplify a voltage difference at the internal nodes during a first phase and a second phase of a clock signal, the sampler circuit including an output unit coupled to the internal nodes to charge additional nodes in the output unit during the first phase of the clock signal and to generate digital output information based on voltages at the additional nodes during the second phase of the clock signal.

In Example 13, the subject matter of Example 12 may optionally include, wherein the pair of transistors includes a first transistor and a second transistor, the sampler circuit includes a third transistor coupled between the first transistor and a supply node, the third transistor including a gate to receive the clock signal, and a circuit component coupled between the first transistor and the supply node.

In Example 14, the subject matter of Example 13 may optionally include, wherein the sampler circuit includes a first additional transistor coupled to the first transistor, a second additional transistor coupled to the second transistor, and a third additional transistor coupled between the second transistor and supply node, the third additional transistor including a gate to receive the clock signal, and an additional circuit component coupled between the second transistor and the supply node.

In Example 15, the subject matter of Example 14 may optionally include, wherein the circuit component includes a transistor, the transistor is to turn on during the first phase of the clock signal, and the additional circuit component includes an additional transistor, the additional transistor is to turn on during the first phase of the clock signal.

In Example 16, the subject matter of Example 14 may optionally include, wherein each of the circuit component and the additional circuit component includes a current source.

In Example 17, the subject matter of Example 12 may optionally include, a first transistor coupled between a first node of the additional nodes and a first internal node of the internal nodes, a second transistor coupled between the first node of the additional nodes and an additional supply node, a third transistor coupled between first node of the additional nodes the additional supply node, a fourth transistor coupled between a second node of the additional nodes and a second internal node of the internal nodes, a fifth transistor coupled between the second node of the additional nodes and the additional supply node, and a sixth transistor coupled between the second node of the additional nodes and the additional supply node.

In Example 18, the subject matter of Example 17 may optionally include, wherein each of the third and sixth transistors is to turn on during the first phase of the clock signal and to turn off during the second phase of the clock signal.

Example 19 includes subject matter (such as a device, an electronic apparatus (e.g., circuit, electronic system, or both), or a machine) including conductive lines on a circuit board, a memory device coupled to the conductive lines, and a processor including a receiver coupled to the conductive lines, the receiver including an equalizer circuit, a sampler circuit coupled to the equalizer, the sampler circuit including a first transistor to receive a first signal of a differential signal pair a second transistor to receive a second signal of the differential signal pair a third transistor to receive a clock signal, the third transistor coupled to the first and second transistors at a node, a circuit component to form a first circuit path between the node and a supply node during a first phase of the clock signal, and the third transistor to form a second circuit path between the node and the supply node during a second phase of the clock signal, and an output unit coupled to the first and second transistors to generate output information based on voltages of the first and second signals during the second phase of the clock signal.

In Example 20, the subject matter of Example 19 may optionally include, wherein the output unit includes a transistor between the first transistor and a first node, and another transistor between the second transistor and a second node, and the output circuit is to charge the first and second nodes during the first phase of the clock signal.

In Example 21, the subject matter of Example 19 or 20 may optionally include, wherein the equalizer circuit includes at least one of a decision feedback equalizer and a feed forward equalizer.

In Example 22, the subject matter of Example 19 may optionally include, further comprising a connector coupled to the processor, the connector conforming with one of Universal Serial Bus (USB), High-Definition Multimedia Interface (HDMI), Thunderbolt, Peripheral Component Interconnect Express (PCIe), and Ethernet specifications.

Example 23 includes subject matter (such as a method of operating a device, an electronic apparatus (e.g., circuit, electronic system, or both), or a machine) including receiving differential signals at gates of transistors, pre-amplifying, during a first phase of the clock signal, a voltage difference between voltages at internal nodes coupled to the transistors, pre-charging, during the first phase of the clock signal, additional nodes of an output unit coupled to the transistors, and generating digital output information at output nodes of the output unit based on voltages at the additional nodes during a second phase of the clock signal.

In Example 24, the subject matter of Example 23 may optionally include, wherein pre-amplifying includes causing a current to flow between a node coupled to the transistors and a supply node.

In Example 25, the subject matter of Example 23 or 24 may optionally include, further comprising turning off a transistor coupled between the transistors and the supply node during the first phase of the clock signal.

Example 26 includes subject matter (such as a device, an electronic apparatus (e.g., circuit, electronic system, or both), or a machine) including means for performing any of the methods of claims 23-25.

The subject matter of Example 1 through Example 26 may be combined in any combination.

The above description and the drawings illustrate some embodiments to enable those skilled in the art to practice the embodiments of the invention. Other embodiments may incorporate structural, logical, electrical, process, and other changes. Examples merely typify possible variations. Portions and features of some embodiments may be included in, or substituted for, those of other embodiments. Many other embodiments will be apparent to those of skill in the art upon reading and understanding the above description. Therefore, the scope of various embodiments is determined by the appended claims, along with the full range of equivalents to which such claims are entitled.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

1. An apparatus comprising:
a first transistor to receive a first signal of a differential signal pair;
a second transistor to receive a second signal of the differential signal pair;
a third transistor to receive a clock signal, the third transistor coupled to the first and second transistors at a node, the third transistor including a terminal directly coupled to a supply node;
a circuit component to form a first circuit path between the node and the supply node during a first phase of the clock signal, and the third transistor to form a second circuit path between the node and the supply node during a second phase of the clock signal; and
an output unit coupled to the first and second transistors to generate output information based on voltages of the first and second signals during the second phase of the clock signal.

2. The apparatus of claim 1, wherein the circuit component includes a current source coupled between the node and the supply node.

3. The apparatus of claim 1, wherein the output unit includes a transistor between the first transistor and a first node, and another transistor between the second transistor and a second node, and the output circuit is to couple each of the first and second nodes to an additional supply node during the first phase of the clock signal.

4. The apparatus of claim 3, wherein the output circuit is to cause the voltage at one of the first and second nodes to change during the second phase of the clock signal.

5. An apparatus comprising:
a first transistor to receive a first signal of a differential signal pair;
a second transistor to receive a second signal of the differential signal pair;
a third transistor to receive a clock signal, the third transistor coupled to the first and second transistors at a node;
a circuit component to form a first circuit path between the node and a supply node during a first phase of the clock signal, and the third transistor to form a second circuit path between the node and the supply node during a second phase of the clock signal;
an output unit coupled to the first and second transistors to generate output information based on voltages of the first and second signals during the second phase of the clock signal
a first additional transistor coupled to the first transistor to receive a first additional signal;
a second additional transistor coupled to the second transistor to receive a second additional signal;
a third additional transistor to receive the clock signal, the third additional transistor coupled to the first and second additional transistors at an additional node; and
an additional circuit component to form a first circuit path between the additional node and the supply node during the first phase of the clock signal, and the third additional transistor to form an additional circuit path between the additional node and the supply node during the second phase of the clock signal.

6. An apparatus comprising:
a first transistor coupled between a first node and an a first internal node;
a second transistor coupled between the first node and a second internal node;
a third transistor including a first terminal coupled to the first node and a second terminal directly coupled to a first supply node;
a circuit component coupled between the first node and the first supply node;
a fourth transistor coupled between the first internal node and a first additional node;
a fifth transistor coupled between the second internal node and a second additional node;
a sixth transistor coupled between the first additional node and a second supply node;
a seventh transistor coupled between the first additional node and the second supply node;
an eighth transistor coupled between the second additional node and the second supply node; and
a ninth transistor coupled between the second additional node and the second supply node.

7. An apparatus comprising:
a first transistor coupled between a first node and an a first internal node;
a second transistor coupled between the first node and a second internal node;
a third transistor coupled between the first node and a first supply node;
a circuit component coupled between the first node and the first supply node;
a fourth transistor coupled between the first internal node and a first additional node;
a fifth transistor coupled between the second internal node and a second additional node;
a sixth transistor coupled between the first additional node and a second supply node;
a seventh transistor coupled between the first additional node and the second supply node;
an eighth transistor coupled between the second additional node and the second supply node;
a ninth transistor coupled between the second additional node and the second supply node, wherein the circuit component includes a transistor coupled in parallel with the third transistor between the first node and the first supply node.

8. The apparatus of claim 6, further comprising:
a tenth transistor coupled between a second node and the second internal node;
an eleventh transistor coupled between the second node and the first internal node; and
a twelfth transistor coupled between the second node and the first supply node.

9. An apparatus comprising:
a first transistor coupled between a first node and an a first internal node;
a second transistor coupled between the first node and a second internal node;
a third transistor coupled between the first node and a first supply node;
a circuit component coupled between the first node and the first supply node;
a fourth transistor coupled between the first internal node and a first additional node;
a fifth transistor coupled between the second internal node and a second additional node;
a sixth transistor coupled between the first additional node and a second supply node;
a seventh transistor coupled between the first additional node and the second supply node;
an eighth transistor coupled between the second additional node and the second supply node;
a ninth transistor coupled between the second additional node and the second supply node
a tenth transistor coupled between a second node and the second internal node;
an eleventh transistor coupled between the second node and the first internal node; and
a twelfth transistor coupled between the second node and the first supply node, further comprising an additional circuit component coupled between the second node and the first supply node.

10. The apparatus of claim 9, further comprising an output latch coupled to the first and second additional nodes.

11. The apparatus of claim 6, further comprising a capacitor coupled to the first node.

12-22. (canceled)

23. The apparatus of claim 5, wherein the circuit component includes a current source coupled between the node and the supply node.

24. The apparatus of claim 5, wherein the output unit includes a transistor between the first transistor and a first node, and another transistor between the second transistor and a second node, and the output circuit is to couple each of the first and second nodes to an additional supply node during the first time interval.

25. The apparatus of claim 7, further comprising a capacitor coupled to the first node.

26. An apparatus comprising:
conductive lines on a circuit board;
a memory device coupled to the conductive lines; and
a processor including a receiver coupled to the conductive lines, the receiver including:
a first transistor to receive a first signal of a differential signal pair;
a second transistor to receive a second signal of the differential signal pair;
a third transistor to receive a clock signal, the third transistor coupled to the first and second transistors at a node;
a circuit component to form a first circuit path between the node and a supply node during a first phase of the clock signal, and the third transistor to form a second circuit path between the node and the supply node during a second phase of the clock signal;
an output unit coupled to the first and second transistors to generate output information based on voltages of the first and second signals during the second phase of the clock signal;
a first additional transistor coupled to the first transistor to receive a first additional signal;
a second additional transistor coupled to the second transistor to receive a second additional signal;
a third additional transistor to receive the clock signal, the third additional transistor coupled to the first and second additional transistors at an additional node; and
an additional circuit component to form a first circuit path between the additional node and the supply node during the first phase of the clock signal, and the third additional transistor to form an additional circuit path between the additional node and the supply node during the second phase of the clock signal.

27. The apparatus of claim 26, further comprising a connector coupled to the processor, the connector conforming with one of Universal Serial Bus (USB), High-Definition Multimedia Interface (HDMI), Thunderbolt, Peripheral Component Interconnect Express (PCIe), and Ethernet specifications.
